(19) United States
(12) Patent Application Publication
(10) Pub. No.: US 2017/0067232 A1
(43) Pub. Date: Mar. 9, 2017

(54) WATER FLOW CONTROL AND SUPPLY SYSTEM

(71) Applicants: Michael J. Colbert, Cave Creek, AZ (US); Michael Shane Mustoe, Scottsdale, AZ (US)

(72) Inventors: Michael J. Colbert, Cave Creek, AZ (US); Michael Shane Mustoe, Scottsdale, AZ (US)

(21) Appl. No.: 15/073,353

(22) Filed: Mar. 17, 2016

Related U.S. Application Data
(63) Continuation-in-part of application No. 14/849,448, filed on Sep. 9, 2015.

(51) Int. Cl. E03B 7/07; F16K 31/02; G05D 7/06

(52) U.S. Cl. CPC E03B 7/071; E03B 7/075; G05D 7/0617; F16K 31/02

(57) ABSTRACT

A water control and supply system for a structure including a main water line coupled between a water supply and a structure. A conduit couples the main water line to a fixture. A valve is carried by the main water line and is movable between an open position allowing water flow and a closed position preventing water flow. A pressure sensor is carried downstream of the valve, and a motion sensor is positioned to detect motion at the water fixture. A control unit receives data from the pressure sensor and the motion detector, moving the valve from the closed position to the open position upon receiving a signal from the motion detector indicating a detected movement and a signal from the pressure sensor indicating a drop in water pressure.

### CROSS-REFERENCE TO RELATED APPLICATION

This application claims the benefit of U.S. patent application Ser. No. 14/849,448, filed 9 Sep. 2015, which claims the benefit of U.S. Provisional Patent Application No. 62/048,743, filed 10 Sep. 2014.

### FIELD OF THE INVENTION

This invention relates to water systems.

More particularly, the present invention relates to controlling and detecting leaks in water systems.

### BACKGROUND OF THE INVENTION

In the field of water systems used in structures, leaks or breaks in pipes as well as leaks in fixtures are a problem. A leak may be troublesome when a person is present and must shut the water off, but if there is no one present, the leak can result in flooding and can cause major damage. To overcome this problem, moisture sensors are often used as warnings of leaks and flooding. These sensors are placed in locations which will be the first areas to experience flooding, and will signal when activated by contact with water. While these devices may be successful in indicating and warning of a flooded area, they do not help indicate a leak before flooding occurs. Another weakness in systems which detect flooding is that they do not detect loss of water through fixtures that use water. In other words, a dripping faucet, or running toilet, which can waste large amounts of water, will not be detected by these flood sensors. Many areas of the world need to conserve water wherever possible. Detecting and stopping a dripping faucet or running toilet can save large volumes of water.

It would be highly advantageous, therefore, to remedy the foregoing and other deficiencies inherent in the prior art.

An object of the present invention is to provide a water flow control and supply system which will indicate a leak before flooding occurs.

Another object of the present invention is to provide a system which can detect a dripping faucet, running toilets or other fixtures that still emit water when they should be off.

Yet another object of the present invention is to provide a system which can detect when a water using feature is needed and turn the water system on with reduced false valve uses.

### SUMMARY OF THE INVENTION

Briefly, to achieve the desired objects and advantages of the instant invention, provided is a water control and supply system for a structure. The water control and supply system includes a main water line coupled between a water supply and a structure. A conduit couples the main water line to a fixture. A valve is carried by the main water line and is movable between an open position allowing water flow and a closed position preventing water flow. A pressure sensor is carried downstream of the valve, and a motion sensor is positioned to detect motion at the water fixture. A control unit receives data from the pressure sensor and the motion detector, to move the valve from the closed position to the open position upon receiving a signal from the motion detector indicating a detected movement, and a signal from the pressure sensor indicating a drop in water pressure. A water control and supply system can also include the control unit receiving data from the pressure sensor and the motion detector to determine if there is a leak in the system when the valve is in the closed position. When a drop in water pressure is detected without receiving a signal from the motion detector indicating a detected movement, a leak is indicated.

In a specific aspect, a plurality of conduits couples the main water line to a plurality of fixtures. The valve is movable between an open position allowing water to flow from the water supply through the main water line to the plurality of conduits, and a closed position preventing flow of water through the main water line to the plurality of conduits. A motion detector is positioned proximate each of the plurality of water fixtures. A control unit receives data from the pressure sensor and the motion detectors, to move the valve from the closed position to the open position upon receiving a signal from at least one of the motion detectors indicating a detected movement, and a signal from the pressure sensor indicating a drop in water pressure.

The control unit of the water control and supply system can include an interface to receive/send instruction from/to a CPU, wherein the CPU compares a stored water pressure value for the closed system with a periodically received water pressure of the closed system to identify a discrepancy therebetween. A data storage device is included in the control unit for storing the stored water pressure value. A timer is provided and includes a timed event to move the valve to the open position for a preset duration.

### BRIEF DESCRIPTION OF THE DRAWINGS

The foregoing and further and more specific objects and advantages of the invention will become readily apparent to those skilled in the art from the following detailed description of a preferred embodiment thereof, taken in conjunction with the drawings in which:

FIG. 1 is a simplified diagram of the water flow control and supply system according to the present invention; and

FIG. 2 is a simplified block diagram of the control unit according to the present invention.

### DETAILED DESCRIPTION OF A PREFERRED EMBODIMENT

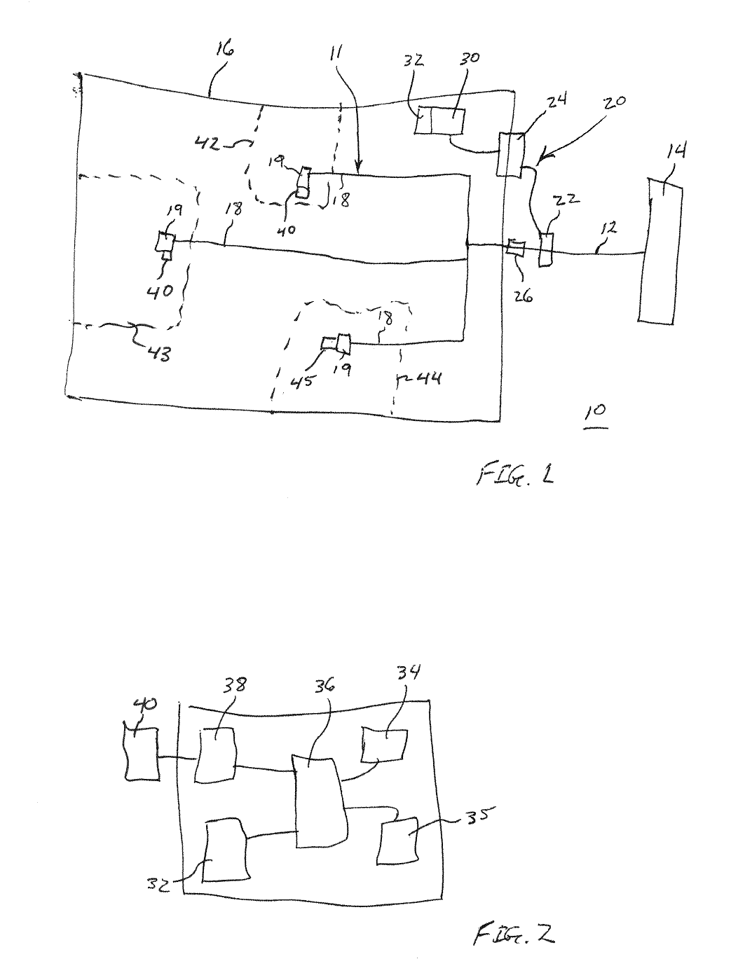

Turning now to the drawings in which like reference characters indicate corresponding elements throughout the several views, attention is directed to FIG. 1 which illustrates a simplified diagram of a water supply and control system generally designated 10. In most structures, such as buildings, houses and the like, a water supply system 11 is provided and includes a main water line 12, supplying water to system 11 from a main water source 14 such as a municipal water supply line, well or the like. Main water line 12 enters a structure 16 and is divided into additional conduits 18 as necessary to transport water to various rooms, locations such as bathrooms, kitchen, laundry room, water delivery fixtures 19 and the like, from water source 14 through main water line 12.

A water flow control system, generally designated 20, is coupled to the water supply system 11 to create water supply and control system 10. Water flow control system 20 can be employed in substantially any of a wide variety of buildings and dwellings having a water supply system, but is particularly applicable for incorporation in residential dwellings. A valve 22 is coupled between main water line 12 and conduits 18 allowing the flow of water from main water line 12 to conduits 18 to be controlled.

Specifically, valve 22 is movable between an open position, allowing water flow, and a closed position, preventing water flow. In the preferred embodiment, valve 22 is an electrically activated ball valve which can be moved between the open position and the closed position by a signal, as will be described presently. It will be understood that any remotely operable valve can be employed, this can also include pneumatic valves, hydraulic valves and the like. Valve 22 is coupled to a power source 24 to provide power for this operation.

A pressure sensor 26 is position downstream of valve 22 between main water line 12 and conduits 18. A control unit 30, having an associated interface device 32, is carried within structure 16 and coupled to valve 22 and pressure sensor 26 by wired or wireless means. In other words, wires can be employed to hardwire the system in place providing communication between the various elements, or a wireless system can be provided, such as radio frequency transponders, coupling the various elements wirelessly. It is also anticipated that the signals can be sent via blue tooth or other devices to smart phones and the like as remote devices separate from the building.

These means are well known in the art and will not be described in further detail.

In operation, control unit 30 can be set to simply open and closed valve 22. Thus a simple button, switch, touch pad or the like is provided on interface device 32 to permit a home owner, renter, manager or other individual user to move valve 22 between the open and closed positions. It will also be understood that by using wireless devices, the control interface can be a remote device carried by an individual, such as a key fob controller, an app on a smart phone and the like. As described previously, communication between control unit 30 and valve 22 can be accomplished wirelessly, in which case control unit 30 and valve 22 are each coupled to power source 24, or by hard wire, in which case valve 22 may be supplied power by control unit 30 or can still be coupled directly to power source 24. By providing a simple remote ability to control valve 22, water can be turned off when not in use and turned on when desire, conveniently and easily. Pressure sensor 26 determines the pressure of water supply system 11 when valve 22 is closed. As long as water supply system 11 remains closed, the pressure will remain constant. This baseline pressure value is maintained in memory in control unit 30 and compared with subsequent pressure measurements when valve 22 is closed. If a leak occurs in water supply system 11, such as one of conduits 18 breaks, or one or more of fixtures 19 leaks, like a running toilet or dripping faucet, the pressure detected by pressure sensor 26 will not match the stored pressure value. If this occurs, interface device 32 will inform the individual user that there is an issue. The individual can be informed of a problem at interface device 32 by a generated signal or message, such as by an alarm, a light, a message on a display and the like, and/or a notification can be sent to smart devices such as smart phones, email and the like. While little water will exit water supply system 11, attempts are made to notify a user before valve 22 is turned to the open position which may result in substantial leakage. Thus, pressure sensor 26 can detect a leak or undesired water loss before there is any catastrophic damage due to flooding.

Pressure sensor 26 can also be used for more than just notification of a catastrophic leak. When the pressure drop is measured against a time frame, it can be determined if there is a large leak, a small leak, or simply a faucet which drips, or a toilet which runs. Any of these reasons or other reasons for water leaving water supply system 11 can be detected by a reduction in pressure detected by pressure sensor 26 over different time periods. If the pressure changes greatly over a short period of time, a large leak may be the cause. If a small change occurs over a longer time, there may be a leaky faucet. Regardless, the system can be tailored to notify the user through interface device 32 and/or remotely when the pressure drops a predetermined percentage (such as 15%) over a predetermined period of time.

With additional reference to FIG. 2, a simplified block diagram of control unit 30 is illustrated. As can be seen control unit 30 includes a timing device 34 and data storage 35 coupled to a CPU 36. A wireless communication device 38 and interface 32 receive/send instruction from/to CPU 36. Timing device 34 can be used in conjunction with pressure sensor 26, as described above, and to set durations for when the valve is in any given state. For example, timing device 34 can be used to keep valve 22 open for a predetermined period of time before closing. Thus, when the water is turned on for use, such as in the morning for showers and breakfast before going to work, timing device 34 can be set to have control unit 30 turn valve 22 to the off position after a predetermined period of time. This period of time is sufficient for the desired activity or usual use during that time of the day and can vary as desired by the user. Thus if the time of use is short, a smaller time period is preset in timing device 34, and if more time is generally needed, a longer time period is preset in timing device 34. These time periods can be set and adjusted through interface 32 as desired to customize the system to particular users. In this manner, if there is a leak, or if a leak in water supply system 11 develops, water will be released into building 16 only when valve 22 is open. Typically, if properly used, valve 22 will only be open when an individual is in the building, and can detect the leak and take appropriate action if the leak occurs when the water is turned on. Otherwise, pressure sensor 26 detects leaks prior to turning the water on and the user is notified. This eliminates flooding due to leaks occurring when an individual is away.

Referring back to FIG. 1, additional elements are employed in system 10 according to the present invention. These elements include motion sensors 40, mounted in areas where water use occurs to detect motion at water fixtures 19. Specifically, motion sensors 40 are mounted in areas of water use such as a bathroom 42, a kitchen 43, a laundry room 44 and the like, proximate one or more of water fixtures 19. In operation, valve 22 is maintained in the closed position, and only moved to the open position when motion sensor 40 detects motion and the water pressure is lowered by opening fixture 19. Motion alone does not mean water is needed, and would result in unnecessarily moving valve 22 to the open position when water is not needed. However, when motion is detected near water fixture 19, and water fixture 19 is turned on (causing a drop in pressure), water is required. Motion sensor 40 is in communication with control unit 30, such as through wireless communication device 38, and pressure sensor 26 is also is in communication with control unit 30, which then turns valve 22 to the open position. While motion sensors 40 are coupled to control unit 30 in a wireless manner, it will be understood that they can also be hardwired to the system if desired. The open position will be maintained as long as motion sensor 40 detects motion and the pressure as detected from pressure sensor 26 remains below the baseline value. After a predetermined time delay, if no motion is detected and the pressure reaches the baseline value, control unit 30 turns valve 22 to the off position. In this manner, system 10 can be maintained in an off position until water use is indicated by the proximity of an individual to water fixture 19 and the water fixture is actually turned on for use. Depending on the size of the structure, and the number of water fixtures 19 and their location, the number of motion sensors 40 can vary. In this manner, simple motion of an individual in an area with a motion detector will not continuously or erroneously open valve 22.

Motion sensors can be placed in specific locations where water is needed for use of that location. In particular, water is typically required whenever someone enters a bathroom. Thus, bathroom 42 is a good location for placement of a motion sensor 40. Some locations can be highly trafficked, and use water only periodically. By limiting system 10 to turning valve 22 to the open position only when a signal from a motion sensor 40 and a drop in pressure is detected by pressure sensor 26, continuous cycling of valve 22 in these highly trafficked areas will be prevented. This is particularly the case with a laundry room which is passed through when entering a garage, a wet bar in a living room or a kitchen, where water is not always used. It will be understood that system 10 can still turn valve 22 to the open position in a timed event or with the use of a specific interface button/switch 45 which can be provided instead of or in addition to a motion sensor. Interface button/switch 45 can be activated to send a signal to control unit 30 through wireless communication device 38 to turn the water on, and can have a preset time interval before turning the water off.

Various changes and modifications to the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. A water control and supply system for a structure, comprising:
a water supply;
a main water line coupled between the water supply and the structure;
a water fixture;
a conduit coupling the main water line to the fixture;
a valve carried by the main water line, the valve movable between an open position allowing water to pass from the water supply through the main water line to the conduit, and a closed position preventing passage of water through the main water line;
a motion sensor positioned to detect motion at the water fixture;
a pressure sensor carried downstream of the valve; and
a control unit receiving data from the pressure sensor and the motion detector, to move the valve from the closed position to the open position upon receiving a signal from the motion detector indicating a detected movement, and a signal from the pressure sensor indicating a drop in water pressure.

2. A water control and supply system as claimed in claim 1 wherein the control unit receiving data from the pressure sensor and the motion detector, will determine there is a leak in the system when the valve is in the closed position by detecting a drop in water pressure without receiving a signal from the motion detector indicating a detected movement.

3. A water control and supply system as claimed in claim 1 wherein the control unit includes an interface to receive/send instruction from/to a CPU wherein the CPU compares a stored water pressure value for the closed system with a periodically received water pressure of the closed system to identify a discrepancy therebetween.

4. A water control and supply system as claimed in claim 3 wherein the control unit further includes a data storage device for storing the stored water pressure value.

5. A water control and supply system as claimed in claim 4 wherein the control unit further includes a timer, wherein the timer includes a timed event to move the valve to the open position for a preset duration before returning to the closed position.

6. A water control and supply system for a structure, comprising:
a water supply;
a main water line coupled between the water supply and the structure;
a plurality of water fixtures;
a plurality of conduits coupling the main water line to the plurality of fixtures;
a valve carried by the main water line, the valve movable between an open position allowing water to flow from the water supply through the main water line to the plurality of conduits, and a closed position preventing flow of water through the main water line to the plurality of conduits;
a pressure sensor carried downstream of the valve; and
a motion detector positioned proximate each of the plurality of water fixtures; and
a control unit receiving data from the pressure sensor and the motion detectors, to move the valve from the closed position to the open position upon receiving a signal from at least one of the motion detectors indicating a detected movement, and a signal from the pressure sensor indicating a drop in water pressure.

7. A water control and supply system as claimed in claim 6 wherein the control unit receiving data from the pressure sensor and the motion detectors, will determine there is a leak in the system when the valve is in the closed position by detecting a drop in water pressure without receiving a signal from at least one of the motion detectors indicating a detected movement.

8. A water control and supply system as claimed in claim 7 wherein the control unit includes an interface to receive/send instruction from/to a CPU wherein the CPU compares a stored baseline water pressure value for the closed system with a periodically received current water pressure of the closed system to identify a discrepancy therebetween.

9. A water control and supply system as claimed in claim 8 wherein the control unit further includes a data storage device for storing the stored baseline water pressure value.

10. A water control and supply system as claimed in claim 9 wherein the control unit further includes a timer, wherein the timer includes a timed event to move the valve to the open position at the timed event for a preset duration before returning to the closed position.

11. A water control and supply system as claimed in claim 6 further including an interface button/switch positioned proximate at least one of the plurality of water fixtures and in communication with the control unit for moving the valve from the closed position to the open position when actuated.

12. A water control and supply system as claimed in claim 11 wherein the control unit further includes a timer for measuring a preset time duration, after the interface button/switch is activated the preset time duration will initiate movement of the valve to the closed position.
